(19) United States
(12) Patent Application Publication
(10) Pub. No.: US 2019/0000290 A1
(43) Pub. Date: Jan. 3, 2019

(54) Connection Device

(71) Applicant: Hilti Aktiengesellschaft, Schaan (LI)

(72) Inventor: John Van TAACK-TRAKRANEN, Muenchen (DE)

(73) Assignee: Hilti Aktiengesellschaft, Schaan (LI)

(21) Appl. No.: 16/060,857

(22) PCT Filed: Dec. 5, 2016
(86) PCT No.: PCT/EP2016/079729

§ 371 Date: Jun. 8, 2018

(30) Foreign Application Priority Data
Dec. 11, 2015 (EP) 15199475.3

(51) Int. Cl. A47L 9/24; A47L 7/00; F16L 25/00; B23Q 11/00

(52) U.S. Cl. CPC A47L 9/242; B23Q 11/0046; F16L 25/0045; A47L 7/0095

(57) ABSTRACT

A connection device for connecting a suction tube to a machine tool includes a tube piece which has a machine tool-side inlet opening, a suction-side outlet opening, and a tube curvature disposed between the inlet opening and the outlet opening. The tube piece has a guiding section disposed between the tube curvature and the suction-side outlet opening where a free end of the suction tube is receivable in the guiding section such that the free end is guided linearly within the guiding section. The connection device also has an end piece arrangeable at the free end of the suction tube and an adapter counter piece arrangeable on the suction tube at a distance from the end piece. The end piece is disposed completely within a volume defined by the guiding section and the adapter counter piece is disposed at least partly within the volume.

### CROSS REFERENCE TO RELATED APPLICATIONS

This application claims the priority of International Application No. PCT/EP2016/079729, filed Dec. 5, 2016, and European Patent Document No. 15199475.3, filed Dec. 11, 2015, the disclosures of which are expressly incorporated by reference herein.

### BACKGROUND AND SUMMARY OF THE INVENTION

The present invention relates to a connection device for connecting a suction tube to a machine tool. The connection device is equipped with a tube piece which has a machine tool-side inlet opening, a suction-side outlet opening, and a tube curvature located between the inlet opening and the outlet opening. The present invention also relates to a machine tool with such a connection device.

Connection devices of the type mentioned in the introduction are essentially known from the prior art. They serve to connect a dust-generating machine tool, for example a wall cutting device or the like, to a suction device via a suction tube.

Connection devices known from the prior art have the disadvantage that during the operation of the machine tool, as a result of which vibrations typically occur, the suction tube can tear or become loose from the connection device. As a result, an undesired dust loading of the environment and health impact of the user of the machine tool may result.

The object of the present invention is to provide a connection device and a machine tool with a connection device in which the suction tube is held particularly securely.

In relation to the connection device, the object is achieved in that the tube piece has a guiding section located between the tube curvature and the suction-side outlet opening, a free end of the suction tube is received in the guiding section such that the free end of the suction tube is guided linearly within the guiding section over a guiding length which corresponds to at least half the tube diameter. For this purpose, the connection device has an end piece arranged at the free end of the suction tube and an adapter counter piece arranged on the suction tube, preferably at a distance from the end piece. The end piece is arranged completely within a volume defined by the guiding section and the adapter counter piece is arranged at least partly within the volume.

Advantageously, the suction tube is prevented from slipping out of the guiding section by the interaction of the end piece and the adapter counter piece, a rotation of the suction tube also being possible in its circumferential direction.

In this regard, the invention includes the knowledge that lateral pulling at the suction tube can in particular lead to undesired tearing of the suction tube. Furthermore, it was found that constructive solutions with a cross-sectional narrowing of the suction tube, which could also favor improved break properties of the suction tube, can be dispensed with. The connection device according to the invention therefore favors a connection between the machine tool and the suction tube being vibration-resistant, the connection being robust in terms of lateral and axial pulling on the suction tube, and the connection also providing maximum possible suction cross-section.

In one particularly preferred configuration, the adapter counter piece is detachably fastened to the suction-side outlet opening. A detachable fastening is preferably implemented by means of a locking unit detachable by rotation. This locking unit can, for example, be designed as a bayonet connection or the like. It has been found to be advantageous when the adapter counter piece, as part of the locking unit, has a stepped brim which preferably corresponds to a suction-side outlet opening designed accordingly. Alternatively or additionally, the adapter counter piece can be designed such that it is held on the suction-side opening, for example by means of a press fit in the region of the suction-side opening.

It has also been found to be advantageous when the adapter counter piece is arranged on the suction tube, it is secured against an axial movement relative to the suction tube. The adapter counter piece is preferably secured only in its axial movement direction relative to the suction tube and, in particular, is freely movable or rotatable radially, i.e., in the circumferential direction in relation to the suction tube.

It has been found to be advantageous when the adapter counter piece has an outer sleeve at least partly fitted to the linear guiding section and/or to the suction-side outlet opening. A press fit between adapter counter piece and guiding section or its suction-side outlet opening can, for example, be implemented via the outer sleeve.

It has also been found to be particularly advantageous when the adapter counter piece has a conical inner sleeve, preferably arranged coaxially to the outer sleeve. The conical inner sleeve, whose widest diameter is preferably located on a side of the adapter counter piece facing the linear guiding section, can, for example, fasten to the adapter counter piece, for example, an alternative suction tube which has an end conical adapter. Suction tubes with smaller diameter can therefore be fastened to the connection device.

It has been found to be advantageous when the diameter of the end piece is larger than the inner diameter of the adapter counter piece. In other words, the smallest outer diameter of the end piece is preferably larger than the largest inner diameter of the adapter counter piece. It has been found to be advantageous when the diameter of the end piece is at least twice as large as the width of the end piece in the axial direction.

In one particularly preferred configuration, the end piece is designed in a cylindrical-circular shape. The end piece further preferably has an inner thread to screw on the suction tube.

It has been found to be advantageous when the tube curvature has a curvature between 100° and 120° and preferably of 110° and/or the guiding section, the end piece and the adapter counter piece are arranged coaxially to one another. A curvature between 1000 and 120° and preferably of 110° has been proven to be particularly advantageous since the dust can be channeled particularly easily through the tube curvature. Furthermore, such a curvature has been proven to be particularly material-efficient for the inside of the tube curvature since only a relatively flat contact surface is hereby provided for the removed dust.

With regard to the machine tool, the object is achieved by a machine tool with a previously-described connection device.

Additional advantages result from the following Figure descriptions. Different exemplary embodiments of the present invention are represented in the Figures. The Figures, the description, and the claims contain numerous features in combination. The person skilled in the art will expediently also consider the features individually and combine them to form suitable additional combinations.

Identical and similar components are labelled in the Figures with the same reference numerals.

### BRIEF DESCRIPTION OF THE DRAWINGS

FIG. 1 is a schematic representation of a connection device according to the invention;

FIG. 2 illustrates a preferred exemplary embodiment of a connection device in a perspective representation;

FIG. 3 is a sectional representation A-A of the view from FIG. 2;

FIGS. 4A-C illustrate an end piece of the connection device according to the invention in different views;

FIGS. 5A-D illustrate an adapter counter piece according to the invention in different views;

FIG. 6 is a sectional representation through an additional exemplary embodiment of a connection device according to the invention; and

FIG. 7 is a perspective representation of a connection device, the adapter counter piece being removed.

### DETAILED DESCRIPTION OF THE DRAWINGS

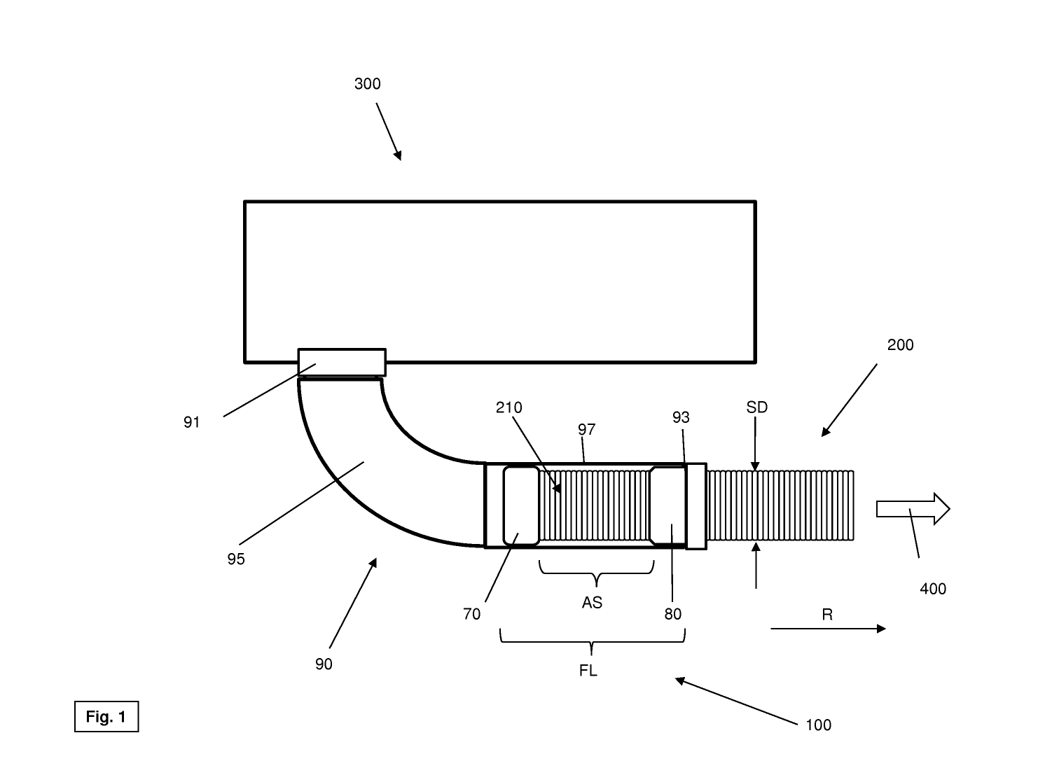

FIG. 1 shows a connection device 100 for connecting a suction tube 200 to a machine tool 300 represented here schematically. The machine tool 300 may be, for example, a cutting device.

The connection device 100 has a tube piece 90 which, in turn, has a machine tool-side inlet opening 91, a suction-side outlet opening 93 and a tube curvature 95 located between the inlet opening and the outlet opening. In the exemplary embodiment represented in the present case, the tube curvature 95 has a curvature of 90°. The connection device 100 is connected to the machine tool 300 via the machine tool-side inlet opening 91.

The tube piece 90 has a guiding section 97 located between the tube curvature 95 and the suction-side outlet opening 93 which is designed linearly in the present case. A free end 210 of the suction tube 200 is received in this guiding section 97. The free end 210 of the suction tube 200 is guided within the guiding section 97 over a guiding length FL which corresponds in the present case to roughly six times half the tube diameter SD.

For this purpose, the connection device 100 has an end piece 70 arranged on the free end 210 of the suction tube 200 and an adapter counter piece 80 arranged on the suction tube 200 at a distance AS from the end piece. In the exemplary embodiment represented in the present case, the distance AS is roughly one and a half times as large as the tube diameter SD. The guiding length FL is, as can be inferred from FIG. 1, larger than the distance AS between end piece 70 and adapter counter piece 80.

As can also be inferred from FIG. 1, the end piece 70 is arranged completely within a volume defined by the guiding section 97 and the adapter counter piece 80 is arranged at least partly within the volume.

The guiding section 97, the end piece 70 and the adapter counter piece 80 are arranged coaxially to one another. Dust discharged from the machine tool 300 is guided via the connection device 100 in the direction of a dust generating unit 400 which is represented here merely schematically by an arrow pointing to the right.

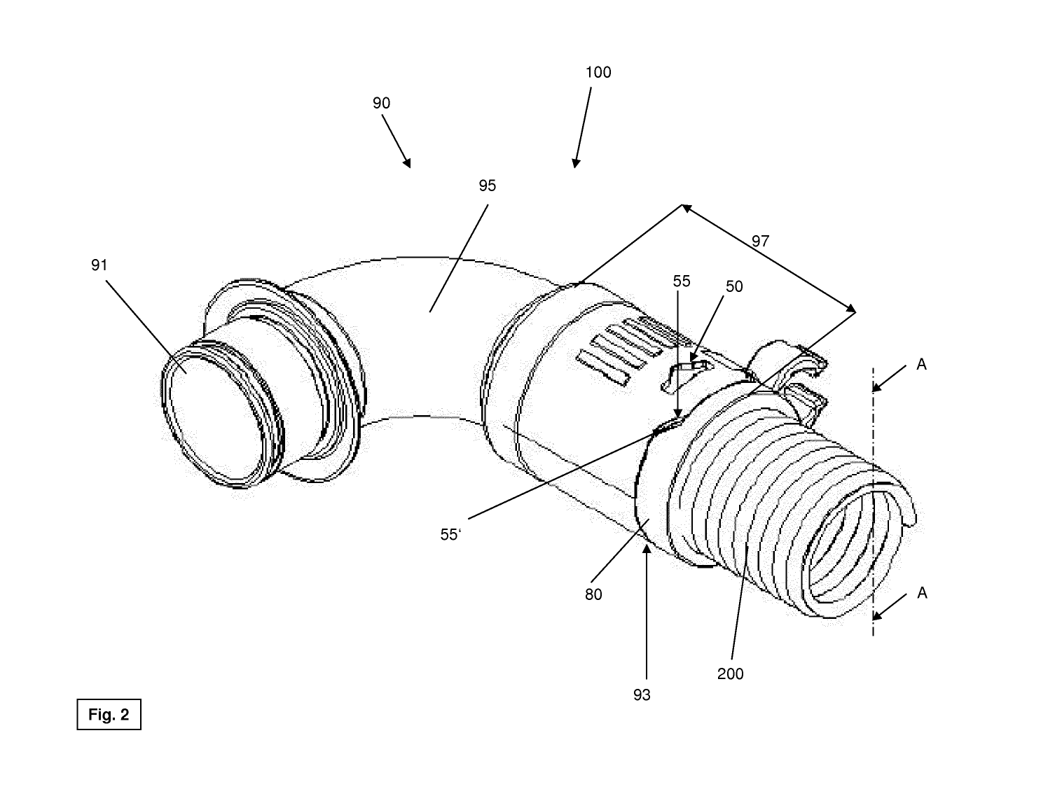

FIG. 2 shows a perspective representation of a connection device 100 with suction tube 200 applied. An inlet opening 91 designed in the shape of a plug can be clearly discerned which can be inserted into a corresponding opening of the machine tool 300 not represented here. The tube piece 90 has an outlet opening 93 on the opposing side. The tube piece 90 has a tube curvature 95 and the linear guiding section 97 between the inlet opening 91 and the suction-side outlet opening 93.

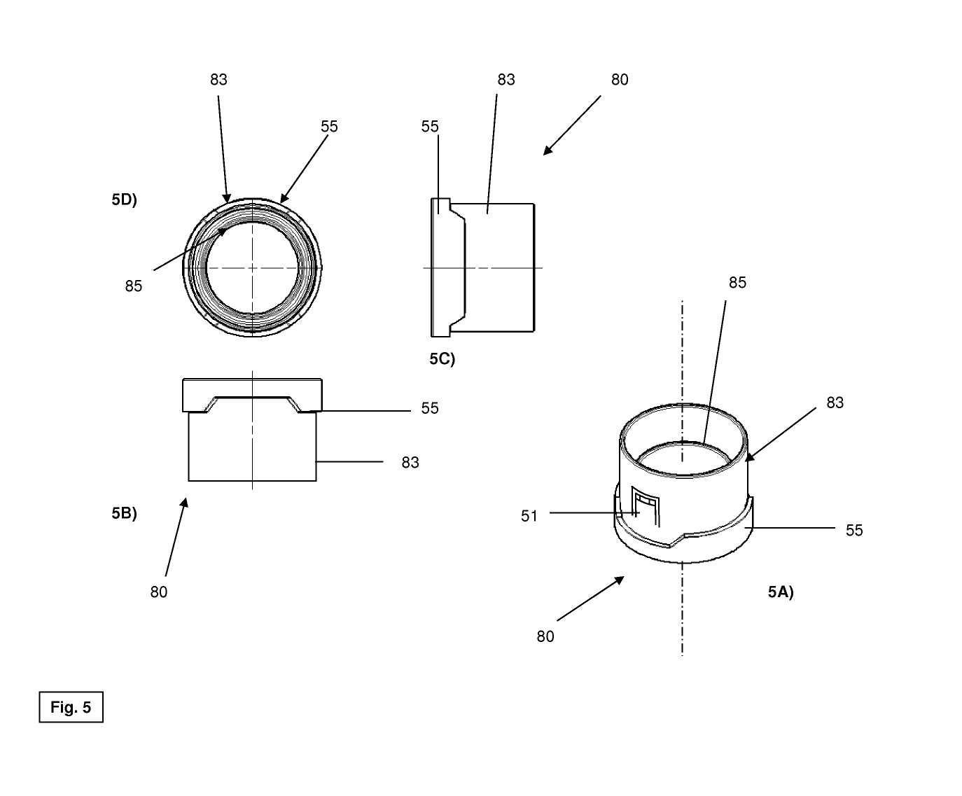

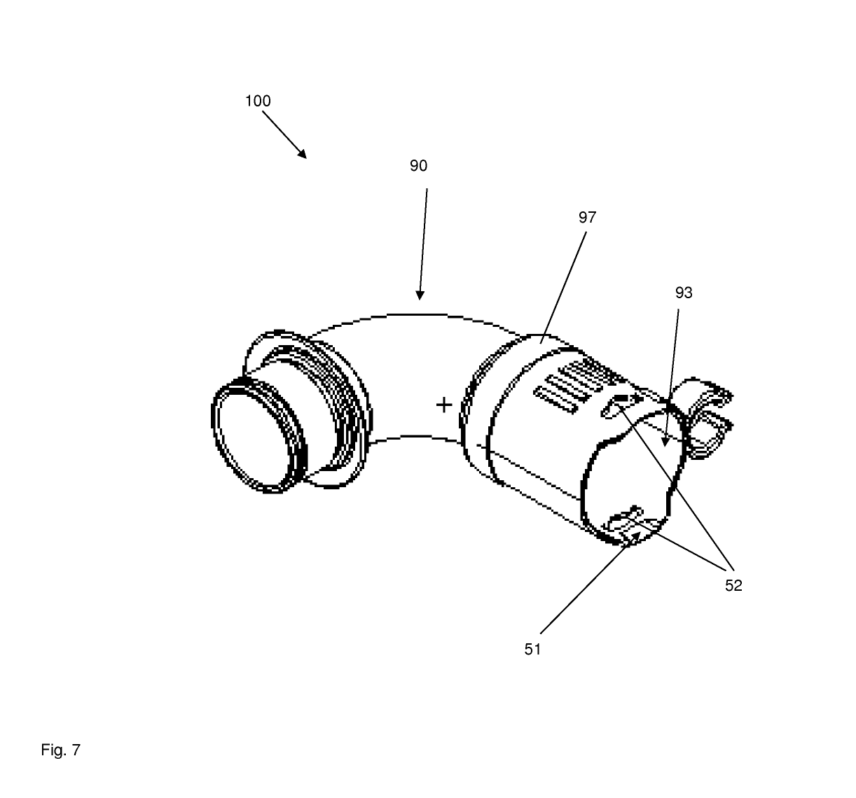

The adapter counter piece 80 is received at least partly in the guiding section 97 in the exemplary embodiment represented in FIG. 2. The adapter counter piece 80 is detachably fastened to the suction-side outlet opening 93 of the connection device 100 by means of a locking unit 50 detachable by rotation, which has a stepped brim 55 arranged on the adapter counter piece 80 in the exemplary embodiment represented in the present case. In correspondence therewith, the suction-side outlet opening 93 is also designed in a stepped manner. The stepped brim 55 on the adapter counter piece 80 can also, for example, be inferred from FIG. 5. A corresponding stepped portion 55′ of the suction-side outlet opening 93 is shown both in FIG. 2 and in FIG. 7.

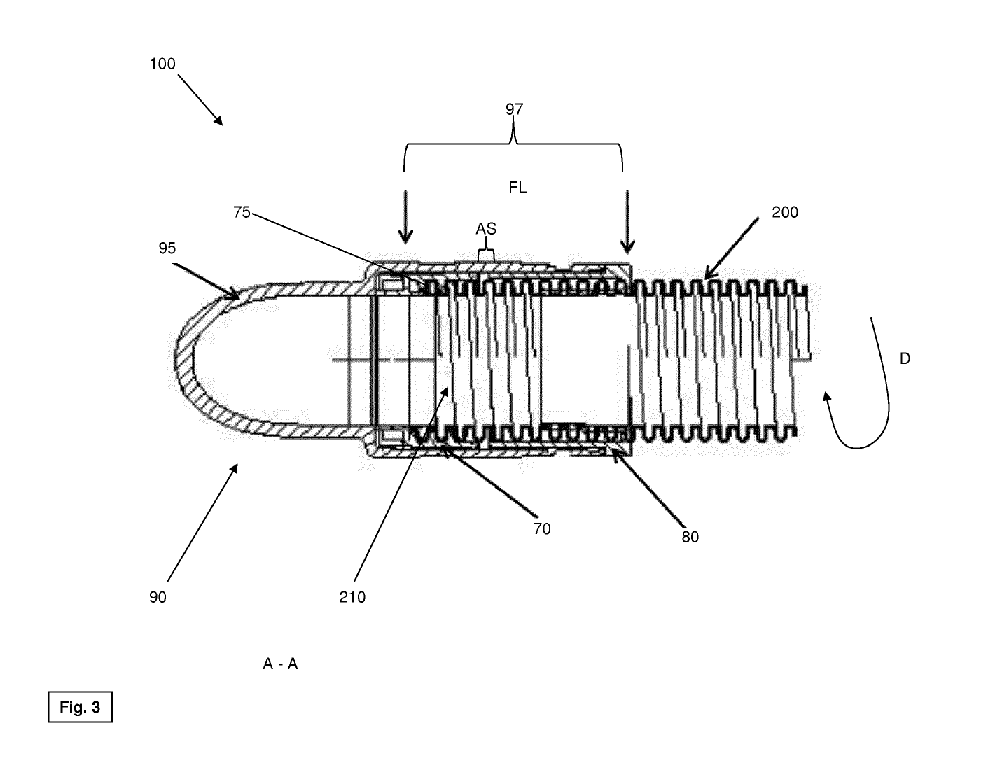

A section line A-A is represented on the right-hand side in FIG. 2, whose sectional view A-A should now be explained more precisely in relation to FIG. 3.

On the left-hand side of FIG. 3, the tube curvature 95 of the tube piece 90 can be clearly discerned. The guiding section 97 is located on the right of this in the direction of the suction tube 200, a free end 210 of the suction tube 200 is guided in the guiding section over a guiding length FL. An end piece 70 is arranged at the end on the free end 210 of the suction tube 200. The adapter counter piece 80 is arranged on the suction tube 200 axially spaced therefrom at a comparatively short distance AS. The suction tube 200 is guided through the adapter counter piece 80.

The inner thread 75 of the end piece 70 is clearly discernible in the sectional representation of FIG. 3 which serves to screw onto the suction tube 200 for its axial securing within the end piece 70. The adapter counter piece 80 is clearly discernible on the right-hand side of the guiding section 97 which is pushed via the suction tube 200. In order to prevent the adapter counter piece 80 moving too far along the suction tube 200, a corresponding stop element, not shown, in the form of a ring can be fastened behind the adapter counter piece 80 in the tube direction R. Such a stop element must, to this end, be tightly connected to the suction tube 200.

The adapter counter piece 80 is detachably fastened on the guiding section 97 such that the suction tube 200 is rotatable as a whole radially in the direction of the indicated rotational direction D, but fixed axially in relation to the guiding section 97.

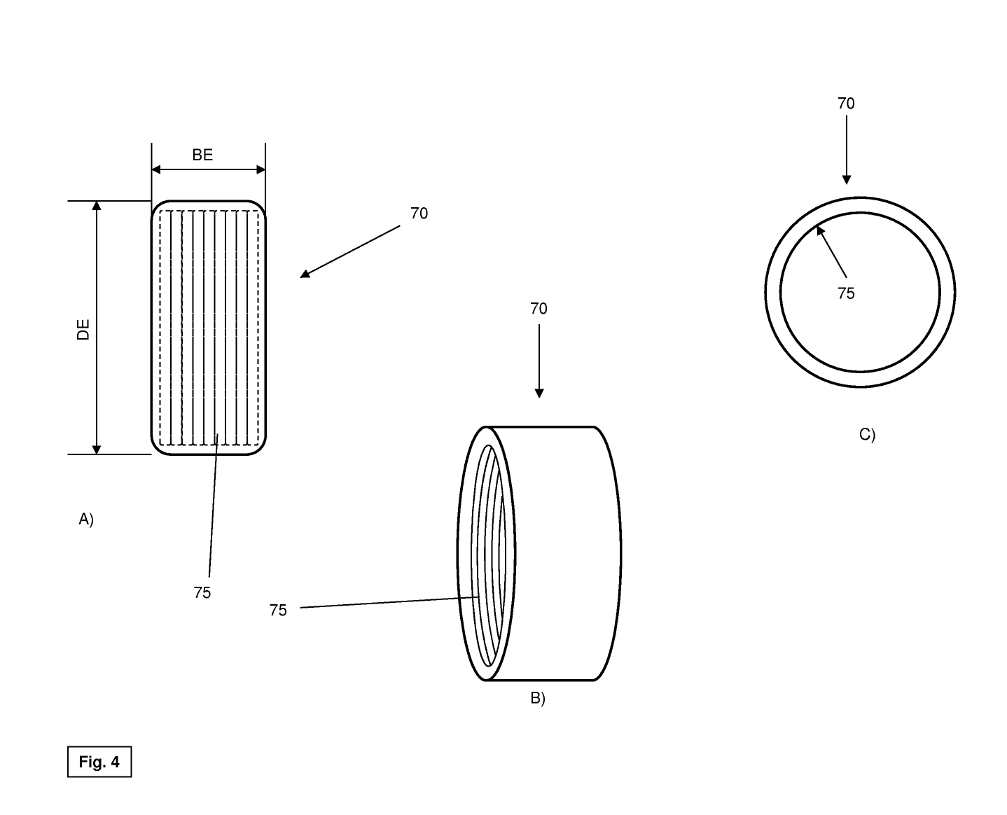

FIG. 4 shows different views of the end piece 70. A section along the diameter DE is represented in FIG. 4A. The inside profile grooves 75 for receiving the suction tube, not shown, which are distributed radially outwards are clearly discernible. The diameter DE of the end piece 70 is, in the exemplary embodiment represented in the present case, roughly twice as large as the width BE of the end piece 70.

FIG. 4B shows a perspective representation of the end piece 70 to further illustrate the profile grooves 75. Lastly, a section is shown radially through the end piece 70 in FIG. 4C. The cylindrical-circular shaped formation of the end piece 70 is clearly discernible.

FIG. 5 shows an adapter counter piece 80 according to the invention, whose outer surface is also clearly discernible in FIGS. 2 and 3 in different representations.

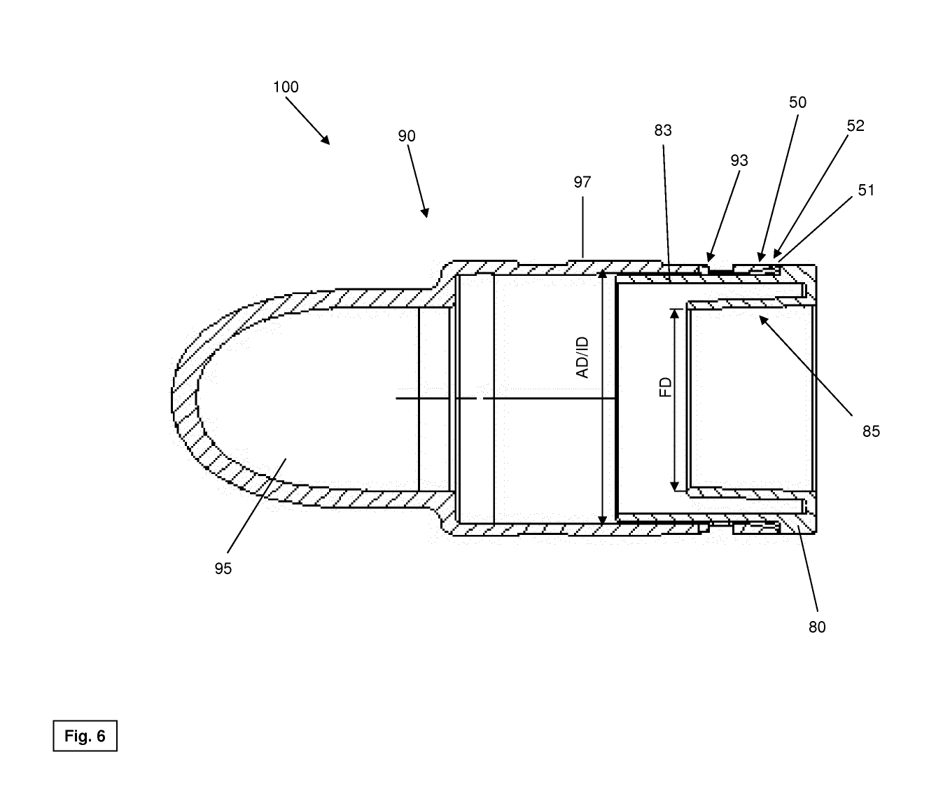

To this end, FIG. 5A firstly shows the adapter counter piece 80 in a perspective representation. A cylindrically-designed outer sleeve 83 of the adapter piece 80 is clearly discernible which is fitted to the suction-side outlet opening (see FIG. 6) by means of transition fit. A stepped brim 55 is designed on the outer sleeve 83 of the adapter counter piece 80 which constitutes a part of the locking mechanism which is provided to detachably fasten the adapter counter piece 80 to the suction-side outlet opening or to the guiding section. The catch lug 51 belonging to the locking unit 50 is positioned on the outer sleeve 83 which is designed as an elastic join part and is connectable in a form-fitting manner to the corresponding receiving portion 52 of the locking unit 50. A conical inner sleeve 85 is arranged coaxially to the outer sleeve 83. The conical design is particularly easy to infer from the bottom view 5D, or from FIG. 6.

The formation of the stepped brim 55 is clearly discernible from FIGS. 5B and 5C, which respectively show a side view of the adapter counter piece 80. In the exemplary embodiment represented in the present case, two protrusions and two depressions are clearly discernible in the circumferential direction which form the stepped portion of the brim 55.

FIG. 6 shows a section through an exemplary embodiment of a connection device 100 according to the invention, the representation of the suction tube 200 being dispensed with for reasons of clarity. It is clearly discernible that the linear guiding section 97 of the tube piece 90 at least partly protrudes into the adapter counter piece 80.

The adapter counter piece 80 has an outer sleeve 83 with an outer diameter AD which is fitted to the inner diameter ID of the guiding section 97. In the exemplary embodiment represented in the present case, a transition fit between the guiding section 97 and the outer sleeve 83 is supposed to be adopted such that the adapter counter piece 80 can be easily inserted into the guiding section 97.

It can also be inferred from FIG. 6 that the adapter counter piece 80 is detachably arranged on the suction-side outlet opening 93 of the tube piece 90, in other words the guiding section 97, by means of the locking unit 50 already described and detachable by rotation.

As can also be inferred from the preferred exemplary embodiment represented in FIG. 6, both the conical inner sleeve 85 and the outer sleeve 83 have a smooth surface on the inside. The smallest free diameter FD of the conical inner sleeve 85 corresponds to the tube diameter SD, which is, for example, shown in FIG. 1.

FIG. 7 lastly shows a connection device 100 without adapter counter piece 80. A receiving portion 52 of the locking unit 50, belonging to the elastic catch lug 51 (see FIG. 6), is clearly discernible, the receiving portion being arranged on the inner circumference of the outlet opening 93.

### LIST OF REFERENCE NUMERALS

50 locking unit
51 catch lug
52 receiving portion
55 brim
55′ corresponding stepped portion
70 end piece
75 inner thread on the end piece
80 adapter counter piece
83 outer sleeve of the adapter counter piece
85 conical inner sleeve of the adapter counter piece
86 profile grooves on the adapter counter piece
90 tube piece
91 machine tool-side inlet opening
93 suction-side outlet opening
95 tube curvature
97 linear guiding section
100 connection device
200 suction tube
210 free end of the suction tube
300 machine tool
400 dust generating unit
AD outer diameter of the outer sleeve
AS distance
BE width of the end piece
DE diameter of the end piece
FD free diameter of the conical inner sleeve
FL guiding length
ID inner diameter of the guiding section
SD tube diameter

1.-8. (canceled)

9. A connection device for connecting a suction tube to a machine tool, comprising:
a tube piece, wherein the tube piece has a machine tool-side inlet opening, a suction-side outlet opening, and a tube curvature disposed between the machine tool-side inlet opening and the suction-side outlet opening;
wherein the tube piece has a guiding section disposed between the tube curvature and the suction-side outlet opening, wherein a free end of the suction tube is receivable in the guiding section such that the free end is guidable linearly within the guiding section over a guiding length which corresponds to at least half a tube diameter of the suction tube;
an end piece, wherein the end piece is disposed completely within a volume defined by the guiding section and is arrangeable on the free end of the suction tube; and
an adapter counter piece, wherein the adapter counter piece is disposed at least partly within the volume and is arrangeable on the suction tube at a distance from the end piece.

10. The connection device according to claim 9, wherein the adapter counter piece is detachably fastenable on the suction-side outlet opening by a locking unit that is detachable by rotation.

11. The connection device according to claim 10, wherein the adapter counter piece has a stepped brim as a part of the locking unit.

12. The connection device according to claim 9, wherein the adapter counter piece, when arranged on the suction tube, is secured against an axial movement relative to the suction tube.

13. The connection device according to claim 9, wherein the adapter counter piece has an outer sleeve that is fitted at least partly to the guiding section and/or to the suction-side outlet opening and has a conical inner sleeve that is disposed coaxially to the outer sleeve.

14. The connection device according to claim 9, wherein the end piece has a cylindrical-circular shape and has an inner thread which is screwable onto the suction tube.

15. The connection device according to claim 9, wherein the tube curvature has a curvature between 100 and 120 degrees and wherein the guiding section, the end piece, and the adapter counter piece are disposed coaxially to one another.

16. A machine tool, comprising:
a connection device according to claim 9.
